(19) United States
(12) Patent Application Publication
(10) Pub. No.: US 2024/0398153 A1
(43) Pub. Date: Dec. 5, 2024

(54) MILK MODULE FOR PREPARING MILK-BASED BEVERAGES

(71) Applicant: HEYLO S.R.L., Bergamo (IT)

(72) Inventors: Alessandro CERIANI, Chignolo D'isola (BG) (IT); Lorenzo IEMMA, Chignolo D'isola (BG) (IT); Antonello FERRANTE, Chignolo D'isola (BG) (IT)

(73) Assignee: HEYLO S.R.L., Bergamo (IT)

(21) Appl. No.: 18/701,526

(22) PCT Filed: Oct. 13, 2022
(86) PCT No.: PCT/IB2022/059827

§ 371 Date: Apr. 15, 2024

(30) Foreign Application Priority Data
Oct. 15, 2021 (EP) 21203004.3
Oct. 11, 2022 (IT) 102022000020949

(51) Int. Cl. A47J 31/44; A47J 31/46

(52) U.S. Cl. CPC A47J 31/4485; A47J 31/461

(57) ABSTRACT

A milk module for producing hot or cold, frothed or non-frothed milk-based beverages has a milk line extending from a container to a dispensing nozzle and an air line extending from an air source and communicating with the milk line. The milk line has a milk pump, a flow restriction arranged on the delivery side of the milk pump, and a milk heater. The milk module has a proportional air solenoid valve arranged along the air line, a pressure sensor arranged along the milk line, and an electronic control unit in communication with the pressure sensor and the proportional air solenoid valve. The electronic control unit is programmed to store data representative of at least one target pressure profile; and control the proportional air solenoid valve based on the pressure of the milk-air mixture measured by the pressure sensor and the target pressure profile.

### CROSS-REFERENCE TO RELATED APPLICATIONS

This patent application is a national stage application filed under 35 U.S.C. § 371 of PCT Application No. PCT/IB2022/059827, filed Oct. 13, 2022, which claims priority to European patent application no. 21203004.3 filed on Oct. 15, 2021, and Italian patent application no. 102022000020949 filed on Oct. 11, 2022, the entire disclosure of each of which is incorporated herein by reference.

### BACKGROUND OF THE DISCLOSURE

### 1. Field of the Disclosure

The present invention relates to a milk module for preparing beverages, in particular hot or cold, frothed or non-frothed milk, from liquid milk of animal or plant origin.

This type of milk modules is used as a stand-alone unit or, more commonly, alongside, or integrated in, machines for preparing coffee-based beverages to form therewith a multi-product preparation unit.

### 2. Description of Related Art

A milk module of the type specified above normally comprises a milk line, which extends from a liquid milk container to a beverage dispensing nozzle and comprises: a milk pump to suck the milk from the container, an air inlet to allow air to be introduced in the milk line on the suction side of the pump, an frothing device arranged downstream of the milk pump, and a heating device arranged normally between the frothing device and the beverage dispensing nozzle.

In use, a given amount of air is introduced into the milk flow sucked from the container, and the resulting milk-air mixture is supplied under pressure to the frothing device to be frothed and then, if necessary, heated by the heating device.

Commonly, the frothing device comprises a flow restriction, for example formed by a fixed nozzle or by a fixed or adjustable throttle valve. The heating device normally comprises a through-flow heater, which can be an electric heater or a heat exchanger. In other cases, the milk or milk-air mixture is heated by injecting a steam flow into the milk line.

As is known to those skilled in the art, the amount of air introduced into the milk line represents an indispensable parameter for preparing frothed beverages having in the cups high requirements from both an organoleptic and an aesthetic point of view. For this reason, recent decades have seen an evolution of the traditional systems based on an ON/OFF air control, wherein the air inlet is opened or closed by means of a solenoid valve with a fixed flow rate, depending on whether a frothed beverage is to be obtained or not, toward more sophisticated systems capable of proportionally controlling the introduction of air in the milk line so that variable amounts of air can be supplied according to the beverage to be prepared.

One of the most commonly used systems for proportionally controlling the amount of air consists in sucking air from the external environment by means of the action of the milk pump and, before introducing the sucked air into the milk line, electronically adjusting the air flow rate by means of a proportional solenoid valve. Normally, the solenoid valve is controlled by an electronic control unit of the milk module according to closed-loop or open-loop control algorithms widely known in the field, based on various operating parameters, such as the type of milk, the temperature of the cold milk or of the milk-air mixture, the milk pump speed, etc.

Some systems using a proportional solenoid valve for adjusting the air flow rate are exemplarily disclosed in the following pieces of prior art:

EP 3 181 021 A1 (Steiner Weggis), in which the amount of air is adjusted by means of a proportional solenoid valve to obtain a given consistency of the milk foam. The proportional air solenoid valve is controlled by an electronic control unit based on the measurement of some operating parameters, such as the type of milk, the temperature of the milk in the milk container, and the temperature of the hot milk-air mixture:

EP 3 039 999 B1 and EP 3 040 000 A1 (Cimbali), in which the amount of air is adjusted by a proportional solenoid valve controlled by an electronic control unit according to a predetermined program stored in the electronic control unit:

EP 3 426 110 B1 (Douwe Egberts), in which the amount of air is adjusted by a proportional solenoid valve controlled by an electronic control unit based on the temperature measured by a sensor arranged adjacent to or at the milk inlet:

WO 2017155403 Al (Douwe Egberts), in which the amount of air is adjusted by a solenoid valve controlled by an electronic control unit according to the type of beverage to be produced.

### SUMMARY OF THE DISCLOSURE

The aim of the present disclosure is to provide a milk module for preparing beverages, in particular frothed or non-frothed milk, which allows the amount of air fed to the milk line to be accurately adjusted so as to improve the organoleptic and aesthetic qualities of the beverage with respect to the prior art systems.

According to the present disclosure, a milk module for preparing beverages, in particular frothed or non-frothed milk is provided, as claimed in the appended claims.

### BRIEF DESCRIPTION OF THE DRAWINGS

FIG. 1 shows a hydraulic diagram of a preferred embodiment of a milk module of the present disclosure.

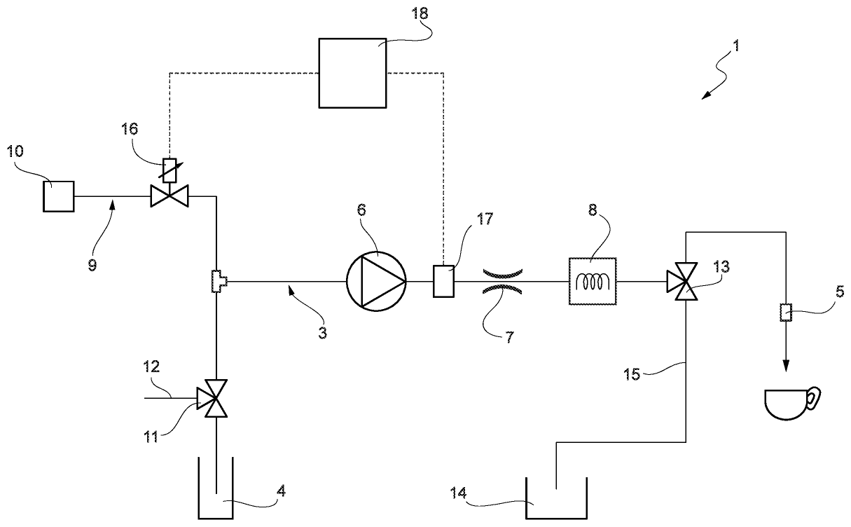

### DETAILED DESCRIPTION OF THE DISCLOSURE

The present disclosure will now be described in detail with reference to the attached figures to allow a person skilled in the art to comprehend, make and use it. Various modifications to the described embodiments will be immediately apparent to the persons skilled in the art and the generic principles described can be applied to other embodiments and applications without departing from the protective scope of the present disclosure, as defined in the attached claims. Therefore, the present disclosure should not be considered limited to the described and illustrated embodiments, but it must be accorded the widest protective scope in accordance with the described and claimed characteristics.

Where not defined otherwise, all the technical and scientific terms used herein have the same meaning commonly used by persons skilled in the art pertaining to the present disclosure. In the event of a conflict, this description, including the definitions provided, will be binding. Furthermore, the examples are provided for illustrative purposes only and as such should not be considered limiting.

In order to facilitate the understanding of the embodiments described herein, reference will be made to some specific embodiments and a specific language will be used to describe the same. The terminology used in the present document has the purpose of describing only particular embodiments and is not intended to limit the scope of the present disclosure.

In the attached Figure, reference numeral I references, as a whole, a milk module 1 for producing hot or cold, frothed or non-frothed milk-based beverages, starting from liquid milk of animal or plant origin.

Depending on its application, the milk module I can be configured to operate as a stand-alone milk module or can be connected to one or more automatic beverage preparation machines, for example coffee machines, to form an integrated multi-product production unit.

The milk module 1 comprises a milk line 3 extending from a milk container 4, preferably housed in a cooler (not shown) designed to keep the milk at a temperature between 3° C. and 5° C., up to a milk dispensing nozzle 5 arranged in a cup filling compartment (not shown).

The milk line 3 comprises, in succession, a milk pump 6 to suck milk from the milk container 4, a flow restriction 7 arranged on a delivery side of the milk pump 6, and a milk through-flow heater 8.

In a different embodiment not shown, the flow restriction 7 could be arranged downstream of the milk heater 8.

Conveniently, the milk pump 6 is a rotary displacement pump, preferably a gear pump.

The flow restriction 7 can be formed by a fixed nozzle or by a fixed or adjustable baffle or throttle valve.

Conveniently, the milk heater 8 is an electric heater, preferably an electromagnetic induction heater.

In a different embodiment not shown, the milk heater 8 could be a heat exchanger or a steam heater to inject a steam jet directly into the milk flow or indirectly by heating a milk duct.

The milk module 1 further comprises an air line 9 extending from an air source, typically an external environment, through an air filter 10 and opening into the milk line 3 in a point thereof on the suction side of the milk pump 6, so that, in use, operation of the milk pump 6 causes, in addition to the suction of the milk from the milk container 4, also the suction of an air flow into the milk line 3.

In a different embodiment, the air line 9 could open into a point of the milk line 3 on the delivery side of the milk pump 6, upstream of the flow restriction 7, and supplied by an air compressor.

The flow restriction 7 defines a localized narrowing of the cross-section of the milk line 3 downstream of the milk pump 6 such that, in use, the milk-air mixture flowing therethrough undergoes a rapid compression and a subsequent rapid expansion that transforms, according to a principle well known to those skilled in the art, the milk-air mixture into frothed milk.

The milk module 1 further comprises a three-way solenoid valve 11 at an inlet of the milk line 3 to selectively put the milk line 3 in fluidic communication with the milk container 4, in a normal beverage preparation configuration, and with a water line 12 in a washing configuration.

The milk module 1 further comprises a further three-way diverter solenoid valve 13 downstream of the through-flow heater 8 to selectively put the milk line 3 in fluidic communication with the milk dispensing nozzle 5 in the beverage preparation configuration and with a wastewater container 14 via a discharge duct 15 in the washing configuration.

In order to adjust the amount of air that is introduced into the milk line 3, the milk module 1 further comprises:
a proportional air solenoid valve 16 arranged along the air line 9, downstream of the air filter 10;
a pressure sensor 17 arranged along the milk line 3, on the delivery side of the milk pump 6, between the delivery side and the flow restriction 7, to measure and output an electrical output indicative of the measured pressure of the milk-air mixture downstream of the milk pump 6; and
an electronic control unit 18 in communication with, in particular electrically connected to, the pressure sensor 17 to receive the electrical output thereof and the proportional air solenoid valve 16 to supply electrical commands thereto, and programmed to control operation of the proportional air solenoid valve 16 based on the pressure of the milk-air mixture measured by the pressure sensor 17, to cause the milk module 1 to produce milk-based beverages having high quality both organoleptically and aesthetically, namely, that contain the correct amount of milk and that a top layer of milk foam has an appropriate height and consistency.

In a different embodiment not shown, the pressure sensor 17 could be arranged downstream of the flow restriction 7 or downstream of the milk heater 8.

In a further embodiment not shown, the pressure sensor 17, instead of being a physical sensor arranged along the milk line 3, could be a virtual sensor implemented by the electronic control unit 18 to estimate the pressure of the milk-air mixture downstream of the milk pump 6 based on an electric current absorption of the milk pump 6, which should therefore be measured for this purpose via known available technologies.

To control operation of the proportional air solenoid valve 16, in one embodiment the electronic control unit 18 is programmed to:
store data representative of at least one target pressure profile P indicative of a time development of a target pressure of the milk-air mixture that is desired to be obtained in the milk line 3, downstream of the milk pump 6; and
closed-loop control the proportional air solenoid valve 16 based on a deviation between the measured pressure of the milk-air mixture downstream of the milk pump 6 measured by the pressure sensor 17 and the target pressure of the milk-air mixture that is desired to be obtained and represented by the target pressure profile P.

In one embodiment, the target pressure profile P is constant over time to cause the proportional air solenoid valve 16 to be controlled so as to maintain a constant pressure of the milk-air mixture in the milk line 3, downstream of the milk pump 6.

In a different embodiment, the pressure profile P has a time-varying development to cause the proportional air solenoid valve 16 to be controlled so that the pressure of the milk-air mixture in the milk line 3, downstream of the milk pump 6, has a time development similar to that of the target pressure profile P.

Exemplarily, a target pressure profile P with a time-varying development could have a trend according to a broken line, formed by a plurality of substantially straight segments comprising a first segment with a first duration, in which the target pressure increases from an initial value, for example 1 bar, to a final value, for example 4 bar, in a given time interval; a second segment with a second duration, in which the target pressure remains substantially constant for a given time interval; and a third segment with a third duration, in which the target pressure returns to the initial value in a given time interval.

In a different embodiment, the electronic control unit 18 is programmed to store data representative of different target pressure profiles P, each of which can be conveniently associated with a respective milk-based beverage that can be produced by the milk module 1 and that can be selected by a user through a graphical user interface (GUI) displayed on a display of an automatic beverage preparation machine with which the milk module 1 is associated or in which it is integrated.

In one embodiment, the electronic control unit 18 is programmed to output electrical commands for the proportional air solenoid valve 16 by implementing, for example, a Proportional-Derivative (PD) controller.

It is understood that controllers other than the one indicated, and which those skilled in the art may deem to be suitable for the purpose, can be implemented.

In order to control operation of the proportional air solenoid valve 16, the electronic control unit 18 is programmed:
to compare the electrical output of the pressure sensor 17 with the target pressure profile P;
as long as the measured pressure of the milk-air mixture downstream of the milk pump 6 does not deviate from the target pressure by an amount greater than a certain tolerance threshold, for example±0.2 bar, to make no adjustment to the proportional air solenoid valve 16;
when, instead, the measured pressure of the milk-air mixture downstream of the milk pump 6 deviates from the target pressure by an amount greater than the aforesaid tolerance threshold, to intervene on the proportional air solenoid valve 16 by increasing or reducing the air flow section by an amount (in percent) proportional to the deviation of the measured pressure from the target pressure, depending on whether the measured pressure of the milk-air mixture downstream of the milk pump 6 is lower or, respectively, higher than the target pressure by an amount greater than the aforesaid tolerance threshold.

To compare the electrical output of the pressure sensor 17 with the target pressure profile P, the electronic control unit 18 is programmed to sample the electrical output of the pressure sensor 17 at a given sampling frequency, e.g., every second, and compare the samples of the electrical output of the pressure sensor 17 with corresponding stored values of the target pressure profile P.

After each adjustment intervention of the proportional air solenoid valve 16, the electronic control unit 18 is programmed to wait for a pressure transition interval before checking whether a further adjustment intervention of the proportional air solenoid valve 16 is to be performed.

Based on what has been described, the advantages that the present disclosure allows to obtain can be appreciated.

In particular, the present disclosure allows a pressure profile of the milk-air mixture downstream of the milk pump 6 to be to defined and set, which is reproduced throughout the dispensing of the beverage and that enables the milk module 1 to produce milk-based beverages that have a high quality both organoleptically and aesthetically, namely, that contain the correct amount of milk and that the top layer of milk foam has an appropriate height and consistency.

In addition, the present disclosure allows the absence of milk in the milk line 3 downstream of the milk pump 6 to be identified and signaled, thus indicating that the milk container 4 is empty.

In addition, the present disclosure allows any abnormalities in the milk module to be diagnosed and signaled, for example a failure of the milk pump.

Finally, it is clear that various modifications can be made to the embodiments described and shown without thereby departing from the scope of the present disclosure, as claimed in the appended claims.

For example, in a different embodiment not shown, air could be introduced into the air line 9 by a compressed air source, for example an air compressor, electronically controlled by the electronic control unit 18. In this embodiment, the proportional air solenoid valve 16 could be omitted and the amount of air introduced into the milk line 9 could be adjusted by means of the appropriate control of the compressed air source, in the example considered the speed of the air compressor. Alternatively, the proportional air solenoid valve 16 could be maintained and arranged downstream of the compressed air source to finely adjust the amount of air introduced into the milk line 3.

A heater could be arranged along the air line 9 to appropriately heat the air introduced into the milk line 3.

1. A milk module for preparing hot or cold, frothed or non-frothed milk-based beverages from liquid milk, the milk module comprising:
a milk line extending from a milk container to a milk dispensing nozzle;
an air line extending from an air source and communicating with the milk line;
a milk pump to draw the liquid milk from the milk container;
a flow restriction arranged on a delivery side of the milk pump;
a milk heater (8);
a proportional air solenoid valve arranged along the air line;
a pressure sensor to measure and output an output indicative of a pressure of a milk-air mixture in the milk line downstream of the milk pump; and
an electronic control unit in communication with (1) the pressure sensor to receive the output thereof and (2) the proportional air solenoid valve to control operation thereof;
wherein, in order to control operation of the proportional air solenoid valve, the electronic control unit is configured to:
store data representative of at least one target pressure profile indicative of a time development of a target pressure of the milk-air mixture that is desired to be obtained in the milk line, downstream of the milk pump; and
control by closed-loop the proportional air solenoid valve based on the pressure of the milk-air mixture measured by the pressure sensor and the target pressure profile.

2. The milk module of claim 1, wherein the pressure sensor is a physical sensor arranged along the milk line, on the delivery side of the milk pump.

3. The milk module of claim 1, wherein the pressure sensor is a virtual sensor designed to measure and output an output indicative of the pressure of the milk-air mixture in the milk line downstream of the milk pump based on an electric current absorbed by the milk pump.

4. The milk module of claim 1, wherein the stored target pressure profile causes the proportional air solenoid valve to be controlled to cause the pressure of the milk-air mixture in the milk line, downstream of the milk pump, to have a substantially constant development over time.

5. The milk module of claim 1, wherein the stored target pressure profile causes the proportional air solenoid valve to be controlled to cause the pressure of the milk-air mixture in the milk line downstream of the milk pump, to have a variable development over time.

6. The milk module of claim 1, wherein the electronic control unit is further configured to store different target pressure profiles, each of which is associated with a respective milk-based beverage that can be produced by the milk module.

7. The milk module of claim 1, wherein the electronic control unit is further configured to control the proportional air solenoid valve by implementing a Proportional-Derivative (PD) controller.

8. An automatic beverage preparation machine comprising the milk module of claim 1.

9. (canceled)
